(19) United States
(12) Patent Application Publication
(10) Pub. No.: US 2014/0297060 A1
(43) Pub. Date: Oct. 2, 2014

(54) SYSTEM FOR CONTROLLING FUNCTIONS OF A VEHICLE BY SPEECH

(71) Applicant: GM GLOBAL TECHNOLOGY OPERATIONS LLC, Detroit, MI (US)

(72) Inventors: Christoph Schmidt, Wiesbaden (DE); Volker Guetzmacher, Nieder-Olm (DE); John Capp, Washington, MI (US); Stefan Eckl, Taunusstein-Wehen (DE); Martin Petermann, Elz (DE); Peter Kahler, Nierstein (DE); Marten Wittorf, Ingelheim (DE)

(73) Assignee: GM GLOBAL TECHNOLOGY OPERATIONS LLC, Detroit, MI (US)

(21) Appl. No.: 14/226,566

(22) Filed: Mar. 26, 2014

(30) Foreign Application Priority Data
Mar. 26, 2013 (GB) 1305436.6

(51) Int. Cl. G10L 25/48; B60W 50/10

(52) U.S. Cl. CPC G10L 25/48; B60W 50/10
USPC 701/1

(57) ABSTRACT

A system for controlling functions of a vehicle by speech is disclosed. The system includes a mobile terminal of a network, speech processor for converting recorded speech into digital characters, and a vehicle-based interface. The mobile network terminal includes a microphone for recording a user's speech, and a terminal interface for communication with the vehicle-based interface. The vehicle-based interface is connected to a subsystem of the vehicle for controlling it based on messages received from the mobile network terminal. The mobile network terminal is adapted to process a string of digital characters derived from the user's speech into a message and to transmit said message to the vehicle-based interface.

### CROSS REFERENCE TO RELATED APPLICATION

This application claims priority to British Patent Application No. 1305436.6 filed Mar. 26, 2013, which is hereby incorporated by reference in its entirety.

### TECHNICAL FIELD

The present disclosure relates to a system which allows a user to control functions of a vehicle by spoken instructions.

### BACKGROUND

A system of this type is known from DE 100 38 803 A1. According to this prior art system, a speech processor on board the vehicle is adapted to recognize spoken instructions such as “open door” or “open trunk”, and to control actuators of a vehicle door or a of a trunk lid according to these instructions, provided that the speaker carries a radio transponder which proves that he is authorized to open the vehicle. In this way, a user does not have to use his hands to open the vehicle. The user can comfortably load the vehicle with goods which must be carried in both hands. However, this conventional system has a problem in that, since the speech processor is located on-board the vehicle and operates on audio data provided by vehicle-based microphones, the reliability of this system strongly depends on the level of ambient noise. In a noisy environment, a user may have to approach the vehicle so closely, in order to enable speech control that he himself obstructs the opening of the door or the trunk lid. Alternately, the user may have to shout in an embarrassing or disruptive way. Further, since the conventional system only verifies the presence of the radio transponder but has no means for identifying a speaker, there is the possibility of the system reacting to instructions spoken by unauthorized persons, e.g. if two vehicle equipped with the conventional system are parked side by side, and transponders of both vehicles are in the vicinity, both vehicles may react to an “open door” instruction spoken by one user, causing the doors to crash into each other.

Another problem of the conventional system has to do with the fact that speech recognition is a recent and rapidly developing technology. Although the computing power and storage capacity required for its execution may be present in most modern vehicles and could be used for speech recognition at no extra cost, a user who wishes to have speech control implemented in his vehicle will in some way or other have to cover the license fees for copyrighted or otherwise protected software.

It would be desirable, therefore, for a vehicle manufacturer to enable speech control of vehicle functions at a minimum cost for the user.

### SUMMARY

According to the present disclosure a system for controlling functions of a vehicle by speech is disclosed which includes a mobile terminal of a network, speech recognition means such as a computer or microprocessor configured to convert recorded speech into digital characters, and on-board control unit of the vehicle. The mobile network terminal includes a microphone for recording a user's speech, and a terminal interface for communication with the on-board control unit. The on-board control unit is connected to at least one subsystem of the vehicle and is configured to control the subsystem based on messages received from the mobile network terminal. The mobile network terminal is adapted to process a string of digital characters derived from the user's speech into a message and to transmit the message to the on-board control unit.

The present disclosure makes use of the fact that many mobile network terminals, such as smartphones or mobile PCs, come equipped with or can be programmed to provide speech recognition functionality. A primary purpose of such speech recognition means is to enable a user to input a text message to be transmitted to the network not by typing, but by simply speaking to the mobile network terminal. So, any user who possesses such a mobile network terminal has already covered the costs related to speech processing software, and the present disclosure enables the user to put a speech processed by such a mobile terminal to a further use.

Since such a mobile network terminal is not permanently installed in the vehicle but, in most cases, will be carried with the user, the microphone will be located close the user's mouth, and there is no need for the user to shout in order to be properly understood by the system, even in a noisy environment.

Further, since the system of the present disclosure may be used not only for controlling the vehicle, there is considerable opportunity for the system to be trained and to adapt to the user's voice, so that a high degree of reliability can be achieved.

The mobile network terminal may include a user interface which enables the user to choose between an first, network operating mode in which a string of digital characters derived from the user's speech is transmitted to the network, for example in the form of a text message; a second, vehicle operating mode in which such a string of digital characters is transmitted to the on-board control unit; and possibly, other operating modes. Since in the vehicle control operating mode the variety of instructions which the speech recognition means are to detect in the user's speech is considerably reduced, these instructions can be recognized with a high degree of reliability, even if only a rather simple and fast recognition algorithm is used.

On the other hand, the mobile network terminal may be adapted to judge from the information content of a string of characters derived from the user's speech whether it contains an instruction to the vehicle and should therefore be transmitted to the on-board control unit, or not. According to this embodiment, the user does not have to choose an appropriate operating mode of the mobile network terminal before being able to control the vehicle, which is clearly convenient if the need or wish to control the vehicle arises unexpectedly.

The mobile network terminal may be adapted to compare the string of digital characters derived from the user's speech with a predetermined set of instructions for controlling a subsystem of the vehicle, and to transmit the string to the on-board control unit only if it is found to match an instruction from the set. The set of instructions that can be carried out by the vehicle-based interface may vary from one vehicle to the other or even, for a given vehicle, depending on previously received instructions. If the on-board control unit is adapted to communicate the set of instructions to the mobile network terminal, the latter can recognize these instructions with high reliability using a simple speech recognition algorithm.

As pointed out above, the mobile network terminal may be a mobile telephone, and the network, hence, a mobile telephone network. Mobile telephone networks conventionally support a SMS or short message service for transmitting a character string which may be derived from a user's speech to another telephone of the network. Of course, the network may also interface the mobile network terminal to the internet. Most mobile telephone networks provide this service, depending on the conditions of contract.

The speech recognition means may be implemented locally in the mobile network terminal. This is an advantage in particular when it must be ensured that an instruction spoken by the user is processed and transmitted to the on-board control unit within a predetermined delay. Else, the speech recognition means may also be implemented in a remote terminal of the network, in which case the mobile network terminal only requires transmission of the recorded speech to the remote terminal and receipt of the string of characters derived therefrom back from the remote terminal. Since the mobile network terminal is thus relieved from the task of speech recognition, its hardware may be rather simple, and its energy consumption is reduced, enabling it to run for a long time without the need to exchange or recharge its battery.

As a security measure, the mobile network terminal may be adapted to transmit an identification key to the on-board control unit, and the on-board control unit can be adapted to compare the transmitted identification key to an expected key before reacting to a message from the mobile network terminal only if the keys match. Control of the vehicle by an unauthorized terminal can thus be prevented.

The object of the present disclosure is further achieved by a method for controlling functions of a vehicle by speech including recording a user's speech in a mobile network terminal, concerting said speech into a string of digital characters, transmitting a message including said string from the mobile network terminal to on-board control unit of said vehicle, the on-board control unit controlling at least one subsystem of the vehicle based on said string of characters.

The present disclosure may further be embodied in a computer program product including program code means which enable a computer to operate as the mobile network terminal or to carry out the method as described above.

The present disclosure may further be embodied in a computer readable data carrier or nono-transitory computer readable data medium having program instructions stored on it which enable a computer to operate as said mobile network terminal or to carry out the method.

Further features and advantages of the present disclosure will become apparent from the subsequent description of embodiments thereof referring to the appended drawings. The description and the drawings disclose features which are not mentioned in the claims. Such features may be embodied in other combinations than those specifically disclosed herein. From the fact that two or more such features are disclosed in a same sentence or in some other kind of common context it must not be concluded that they can only appear in the combination specifically disclosed; rather, any feature of such a combination may appear without the others, unless the description gives positive reason to assume that in that case the present disclosure would be inoperable.

### BRIEF DESCRIPTION OF THE DRAWINGS

The present disclosure hereinafter will be described in conjunction with the following drawing figures, wherein like numerals denote like elements, and:

FIG. 1 is a schematic view of a motor vehicle and a system for controlling functions thereof according to the present disclosure;

FIG. 2 is a schematic flowchart of a control process carried out in the mobile network terminal of the system of FIG. 1 according to a first embodiment of the present disclosure; and

FIG. 3 is a flowchart of a control process carried out in the mobile network terminal according to a second embodiment.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

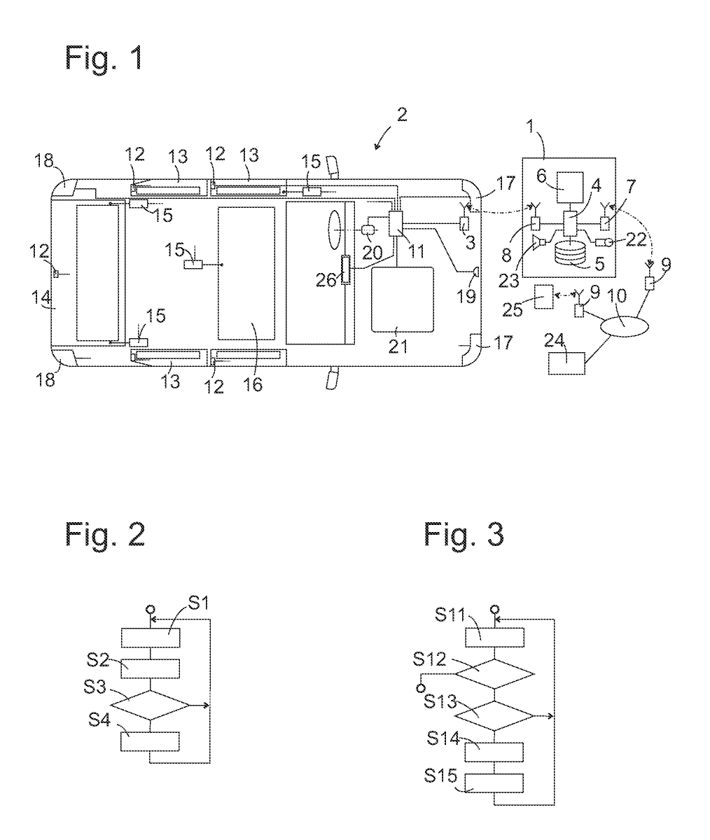

In FIG. 1, reference numeral 1 denotes a mobile network terminal, in particular a smartphone, which is used for controlling certain functions of a motor vehicle 2 through onboard control unit or means of the vehicle. The mobile network terminal 1 has a conventional hardware structure, including a CPU 4, storage means 5 into which various programs for execution by the CPU 4 can be stored, a user interface 6, typically in the form of a touchscreen, a long range radio interface 7, e.g. according to GSM or UMTS standards, for communicating with a base station 9 of a cell phone network 10, and a short range radio interface 8, typically a Bluetooth or WLAN interface, for communicating with a vehicle-based interface 3.

Vehicle-based interface 3 and an on-board computer 11 connected to it form the on-board control unit of motor vehicle 2. Examples of subsystems of vehicle 2 that are controlled by on-board control unit shown in FIG. 1 are locks 12 of doors 13 or of a trunk lid 14, actuators 15 for opening and/or closing the doors 13, the trunk lid 14 or a slidable roof 16, front and/or rear lights 17, 18. Other subsystems, in particular sophisticated driver assistance systems, may in part be the embodied by the on-board computer 11 itself. For instance, the on-board computer 11 may be connected to a plurality of radar sensors 19 distributed around the periphery of the vehicle 2, to a steering wheel actuator 20 and to the engine/gear box 21, in order to form a parking assistance system which autonomously controls the movement of the vehicle 2 into or out of a parking space.

A user interface 26 may be provided which enables the driver to specify to onboard computer 11 for which of the various subsystems 12, 15, etc. controlled by computer 11 voice control shall be enabled.

As is usual for a smartphone or a mobile PC, a microphone 22 and a loudspeaker 23 may be directly integrated into a common casing with CPU 4, storage means 5 and user interface 6. If the mobile network terminal 1 is worn e.g. in a clothing pocket, such an integrated microphone may have difficulties in properly recording the user's speech. Therefore, in the context of the present disclosure, it may be convenient for the user to wear a headset connected to the mobile network terminal 1, so that a microphone of the headset may be used for recording his speech.

FIG. 2 is a flowchart of a control process carried out in the CPU 4 of mobile network terminal 1 according to a first embodiment of the present disclosure. In step S1 of this process, the CPU 4 is waiting for a distinct audio signal from microphone 22. When such an audio signal is received, it is subjected to speech recognition in step S2. The speech recognition algorithm used here employs a standard vocabulary of the user's language and can output any word from this vocabulary which has a sufficient phonetic resemblance to the input audio signal e.g. in the form an ASCII character string (“general purpose algorithm”). In other words, the general purpose algorithm is not limited to the use automotive terms which would be likely to occur in an instruction addressed to the vehicle 2.

Such a general purpose algorithm requires considerable processing power and storage capacity. Although such an algorithm and its data may be stored locally in storage means 5 and executed by the CPU 4 itself, it may be preferable to implement the algorithm in a remote speech processor 24 and to have the CPU 4 only convert the audio signal into digital data, e.g. a WAV file, which is then transferred to remote speech processor 24 via the cell phone network 10 and, eventually, the internet. The speech processor 24 detects spoken words in the audio file and returns these to the mobile network terminal 1.

Step S3 verifies whether the character string output by the speech recognition algorithm is a valid instruction which on-board computer 11 is capable of processing. An efficient and fast way to do this is by comparing the character string to a set valid instructions stored locally in memory 5 of mobile network terminal 1. Since the on-board computer 11 will know which subsystems of the vehicle are connected to it and are capable of being voice-controlled, or which of these have been allowed to be voice-controlled by the driver, and what instructions directed to these subsystems it supports, this set of instructions should preferably be uploaded from on-board computer 11 to mobile network terminal 1 prior to the start of the procedure of FIG. 2. If the character string is different from all instructions of the set, it is assumed not to be an instruction directed to the vehicle 2, and it is processed otherwise in step S4, described below. Else, it is included in a message which is transmitted to vehicle-based terminal 3 for execution by on-board computer 11.

A simple alternative way of verifying whether the character string is a valid instruction is to transmit the character string in a message to vehicle-based terminal 3 and to wait for a reply from the latter. If the mobile network terminal 1 receives an acknowledgment from vehicle-based terminal 3, then the string was a valid instruction and has been or is being processed by on-board computer 11, and the process returns to step 51 to wait for further audio signals. Else, if an error message is received as reply from vehicle-based terminal 3, the string was no valid instruction and could not be processed.

In that case it is forwarded to some other process running on mobile network terminal 1, e.g. in order to be made use of in step S4 as part of an SMS message which is displayed on a screen of user interface 6, and is transmitted to another terminal 25 connected to cell phone network 10 when complete. It might also be interpreted as an instruction or part of an instruction for controlling the communication of terminal 1 within the network 10, e.g. as the phone number or part of the phone number of a participant such as terminal 25, as an instruction for selecting/changing the operating mode of terminal 1, and the like.

Any message transmitted from mobile network terminal 1 to vehicle-based terminal 3 in step S3 may include key data, e.g. an IMEI number of terminal 1, which enables onboard computer 11 to verify the origin of all received messages and to ignore those which come from a terminal which is not cleared to control functions of the vehicle subsystems.

FIG. 3 illustrates a second embodiment of the control process. Here, just as in step S1 of FIG. 2, in a first step S11 CPU 4 waits for distinct audio signal from microphone 22. When such an audio signal is received, CPU 4 decides in step S12 whether it is in a vehicle controlling mode or not. Processing steps which ensue if it is not in the vehicle controlling mode are not subject of the present disclosure and are not described here. If it is in the vehicle controlling mode a speech recognition algorithm executed in step S13 judges the acoustic similarity between the detected audio signal and a set of audio patterns, each of which corresponds to an instruction supported by on-board computer 11. If the similarity to at least one of these patterns is above a predetermined threshold, the instruction corresponding to the most similar pattern is identified as the instruction spoken by the user, and is transmitted to the vehicle-based interface 3 for execution in step S14. If no pattern exceeds the predetermined similarity threshold in step S13, it is assumed that no instruction was spoken, and the process returns directly to step S11.

Since in this process an audio signal received by microphone 22 is compared not with the complete vocabulary of the user's language but only with a very small number of predetermined words or expressions, a quick and simple algorithm is sufficient to identify spoken instructions with a high degree of reliability.

Not all instructions supported by vehicle-based interface 3 may be applicable at any time. For instance, by a first instruction, e.g. “headlights” the user may have selected a subsystem to which a subsequent instruction will apply. In that case, as the next instruction, “on” or “off” may make sense, but “open” or “close” does not. Conversely, if a first instruction specifying a certain activity such as “open” has been identified, a subsequent instruction can be expected to identify a subsystem to which the first instruction is to apply. In case of an “open” instruction, such a subsystem might be one of the doors 13, the trunk lid 14 or the slidable roof 16, but not the lights 17, 18. Therefore, in the process of FIG. 3, the reliability of speech recognition can be improved if whenever an instruction has been transmitted in step S14, a set of instructions among which the next instruction is to be selected is updated in step S15. Preferably, in step S15, vehicle-based interface 3 acknowledges receipt of a valid instruction from mobile network terminal 1 by transmitting to it a list of instructions which might possibly follow the received instruction. If the process of FIG. 3 is repeated based on a subsequent audio signal from microphone 22, CPU 4 will try to identify the subsequent audio signal as an instruction from the set communicated previously in step S15. I.e. if in a first iteration of the process of FIG. 3, an instruction “headlights” has been identified, the vehicle-based interface 3 acknowledges receipt of the instruction by a message to mobile network terminal 1 which specifies “on” and “off” as the only possible valid instructions that may follow.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-14. (canceled)

15. A system for controlling functions of a vehicle by speech, comprising:
a mobile terminal on a network, the mobile terminal including a microphone for recording a spoken message, and a terminal interface configured to communicate with an onboard control unit of a vehicle; and
a speech processor associated with the mobile terminal and configured to convert the spoken message into a digital message accessible by the terminal interface;
wherein the on-board control unit is connected to at least one subsystem of the vehicle and configured to control the at least one subsystem based on the digital message received from the terminal interface.

16. The system of claim 15, wherein the mobile terminal further h comprises a user interface having a mode selector configured to operate the mobile terminal in a first operating mode in which the digital message is transmitted to the network and a second operating mode in which the digital message is transmitted to the on-board control unit.

17. The system of claim 16, wherein the mobile terminal is configured to evaluate the on-board control unit can process the digital message for controlling the at least one subsystem.

18. The system of claim 17, wherein the mobile network terminal is configured to evaluate the on-board control unit by comparing the digital message with a set of valid instructions.

19. The system of claim 16, wherein the mobile terminal is configured to compare the digital message with a set of instructions for controlling the at least one subsystem, and to transmit the digital message to the on-board control unit when the digital message matches an instruction from the set of instructions.

20. The system of claim 19, wherein the on-board control unit comprises a memory to store the set of instruction, and wherein the on-board control unit is configured to communicate the set of instructions to the mobile terminal.

21. The system of claim 16, wherein the network comprises a mobile telephone network, and the mobile terminal comprises is a mobile telephone operable on the mobile telephone.

22. The system of claim 16, wherein the network interfaces the mobile terminal to an internet.

23. The system of claim 16, wherein the mobile terminal further comprises the speech processor.

24. The system of claim 16, further comprising a remote terminal on the network having the speech processor, wherein the mobile terminal is configured to transmit the spoken message to the remote terminal and to receive digital message from the remote terminal.

25. The system of claim 16, wherein the on-board control unit further comprises a memory to store an expected key, and wherein the mobile terminal unit is configured to communicate an identification key to the on-board control unit, and the on-board control unit controls the at least one subsystem when the identification key and the expected key correspond.

26. A method for controlling functions of a vehicle by speech comprising:
recording a spoken message on a mobile terminal;
converting the spoken message into a digital message having a string of digital characters;
transmitting the digital message from the mobile terminal to an on-board control unit of a vehicle;
controlling at least one subsystem of the vehicle with the on-board control unit in response to the digital message.

27. A non-transitory computer readable medium storing a program causing a computer to execute image process to carry out the method of claim 26.
